(19) United States
(12) Patent Application Publication
(10) Pub. No.: US 2022/0134945 A1
(43) Pub. Date: May 5, 2022

(54) U-Turn Indication System

(71) Applicant: Cheryl Lynn Hoffman, Clearwater, FL (US)

(72) Inventor: Cheryl Lynn Hoffman, Clearwater, FL (US)

(21) Appl. No.: 17/088,886

(22) Filed: Nov. 4, 2020

(51) Int. Cl. B60Q 1/38; B60Q 1/00; B60Q 1/26; B60Q 1/34; G08G 1/07

(52) U.S. Cl. CPC B60Q 1/38; B60Q 1/0052; B60Q 1/0076; G08G 1/07; B60Q 1/2607; B60Q 1/2696; B60Q 1/343; B60Q 1/0088

(57) ABSTRACT

A U-turn indication system having a signal light retained in a housing integrally formed within a motor vehicle having a plurality of arrows positioned in a radiused orientation to alert surrounding drivers or pedestrians of a U-Turn procedure with a series of lights. This U-turn indication system is mechanically actuated by a switch located inside the interior of the motor vehicle while the signal indicator is located on at least one exterior surface of the motor vehicle. The U-turn indicator having light emitting units is positioned within a light housing of the motor vehicle and is configured to be visually located by pedestrians, drivers of oncoming vehicles, and/or drivers of approaching vehicles.

### BACKGROUND OF THE INVENTION

### 1. Field of the Invention

This innovation relates, generally, to a signal indicator system for a motor vehicle. More particularly, it relates to a U-turn indication system having components integrally formed within a motor vehicle and/or in electrical communication with a remote traffic light to visually alert pedestrians, oncoming drivers, and/or approaching drivers of an intended U-turn by a motor vehicle.

### 2. Background Art

Currently, motor vehicle accidents involving U-turns have been recorded as contributing to accidents ranging from property damage, to personal injury, and/or even fatalities. It would be more desirable for motorist safety to be enhanced with an automotive U-turn signaling alert system configured to visually notify both pedestrians and other drivers that a vehicle intents to perform a U-turn. Motor vehicles in today's market do not address this need, thus, motor vehicles are completely silent of a U-turn indication system in electronic communication with pedestrian signals or hanging traffic lights. There is a long felt, yet unfulfilled need for a motor vehicle to have a U-turn indication system having a plurality of light emitting units both on a vehicle and on traffic lights and/or pedestrian signals configured to illuminate and result in a chase lighting effect to maximize the attention gain of pedestrians, drivers of oncoming motor vehicles, and/or drivers of approaching motor vehicles.

Many vehicles currently being manufactured in the automotive industry have a plurality of alert systems utilizing light emitting units such as standard turn signals located on many of the exterior surfaces of a motor vehicle. However, these turn signals do not currently differentiate between a left and/or right turn and a U-turn, which is critical element to enhanced motorist safety. Drivers making a U-turn typically take longer time to perform a 180-degree rotation to reverse the direction of travel compared to that of a standard left and/or right turn. Indicating to oncoming traffic that a U-turn will be performed in advance of the procedure may prevent a potential impact from an oncoming vehicle contacting the front and/or the side of the vehicle performing the U-turn. Further, indicating to approaching traffic that a U-turn will be performed in advance of the procedure may prevent a potential impact from an approaching vehicle contacting the rear of the vehicle performing the U-turn, as the acceleration of a U-turn is less than that of a left and/or right turn.

Marked pedestrian crossings are most commonly found at intersections, but they may be positioned at other locations on busy roads that would otherwise be too unsafe to cross without pedestrian signal assistance due to vehicle numbers, speed or road widths. Pedestrian signals are also commonly installed where large numbers of pedestrians are attempting to cross such as in shopping areas or where vulnerable road users such as school children regularly cross. A pedestrian crossing or a crosswalk is a place designated for pedestrians to cross a road, a street, or an avenue. A pedestrian crossing sign or signal is used in some on road traffic and road signs having an image of a “red” colored hand indicating to a pedestrian to not walk and a “white” colored body indicating to a pedestrian that it is safe to walk. Alternatively, many street crossings have pedestrian signals that show the words WALK and DON'T WALK or show a WALKING PERSON in white and a RAISED HAND in orange. Pedestrian signals direct pedestrians while crossing the street. The WALK or WALKING PERSON appears when it is legal to start crossing. There is a need to indicate to a pedestrian of any U-turn activity to enhance their safety when walking during across a street. Thus, the pedestrian signals should have a U-turn indicator in wireless electrical communication with the U-turn signal of a vehicle so that they are in sync for a real-time visual indication to alert an individual of a vehicle's intention of making a U-turn.

However, in view of the prior art considered as a whole at the time the present invention was made, it was not obvious to those of ordinary skill in the pertinent art how the identified needs could be fulfilled.

### SUMMARY OF THE INVENTION

The long-standing but heretofore unfulfilled need for a U-turn indication system having a signal light retained within a housing integrally formed within a motor vehicle having a plurality of arrows positioned in a radiused orientation to visually alert surrounding drivers or pedestrians of a U-turn procedure with a series of chase lights illuminating one after the other. This U-turn indication system is mechanically actuated by a switch located inside the interior of the motor vehicle. The switch is electrically connected to the visual signal indicator which is located on at least one exterior surface of the motor vehicle. The U-turn indicator having light emitting units is positioned within a light housing of the motor vehicle and is configured to be visually located by pedestrians, drivers of oncoming vehicles, and/or drivers of approaching vehicles, and which also includes improvements that overcome the limitations of prior art U-turn signaling systems is now met by a new, useful, and non-obvious invention.

Further, a plurality of arrow shaped light emitting units in a radiused and/or substantially U-shaped orientation are configured to have a chase lighting system and are retained within a housing having a transparent lens located on at least one and/or a plurality of exterior surfaces of a motor vehicle. A chase lighting system is an electrical application in which strings of adjacent light emitting units such as light emitting diodes (LEDs) cycle on and off frequently to give the effect that the lights are moving along the string. This chase lighting system is more desirable to be incorporated into a signaling alert system because the alternating sequence of lights being illuminated in a radiused configuration will differentiate the U-turn signal from the standard left and/or right turn signal with intermittent blinking and/or flashing lights. It is within the scope of this current invention for a plurality of company logo shaped light emitting units to be configured in a radiused and/or substantially U-shaped orientation and are retained within a housing having a transparent lens located on at least one and/or a plurality of exterior surfaces of a motor vehicle.

In a preferred embodiment, the U-turn signal indicator of a vehicle can activate the illumination of U-turn signal lights retained within a housing of a vehicle simultaneously with the activation of U-turn signal lights retained on a remote signal indicator such as a pedestrian cross walk signal, traffic lights, and/or hanging traffic lights. It is within the scope of this invention for a remote signal indicator to be a location that is not connected to the vehicle. The housing of a vehicle is located on any front, side, and/or rear portion of a vehicle including, but not limited to, within a side headlight, a side view mirror, a tail light, a turn-signal light, a housing retained on a bumper, a housing connected to a window and/or a windshield. The benefit of this simultaneous activation of both the vehicle U-turn signal and the remote signal indicator

### BRIEF DESCRIPTION OF THE DRAWINGS

For a fuller understanding of the nature and objects of the invention, reference should be made to the following detailed description, taken in connection with the accompanying drawings, in which:

FIG. 1 is a rear perspective view of the novel U-turn signal indicator of a motor vehicle retained in a housing having a transparent lens;

FIG. 2 is a perspective view of the novel U-turn signal indicator retained in a housing having a transparent lens;

FIG. 3 is a perspective view of the novel U-turn signal indicator of a first and a second motor vehicle in wireless communication with a remote U-turn signal indicator being a hanging traffic light;

FIG. 4 is a perspective view of an instrument panel of a motor vehicle having a U-turn indicator;

FIG. 5 is a perspective view of a mechanical actuating switch of a motor vehicle rotated between an on position and an off position; and,

FIG. 6 is a circuit diagram of the electrical components of the novel U-turn indicator system.

### DETAILED DESCRIPTION OF THE PREFERRED EMBODIMENT

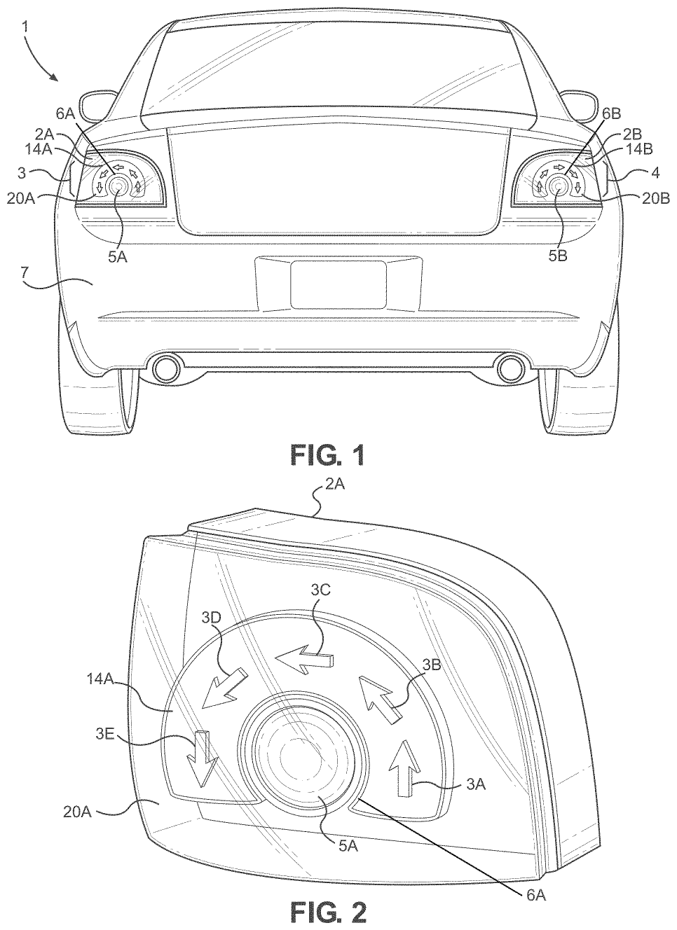

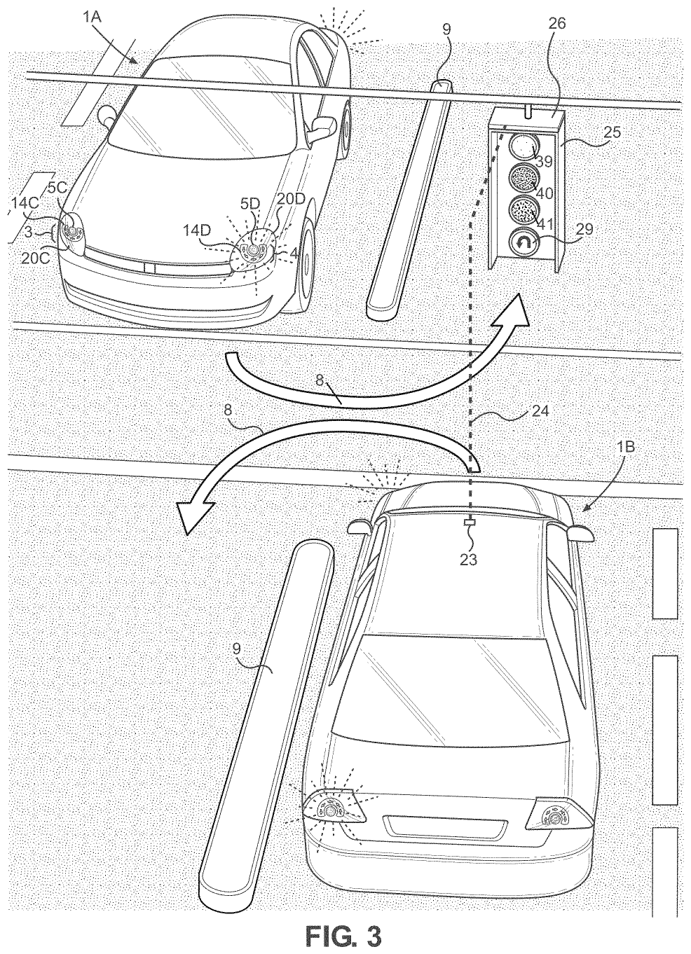

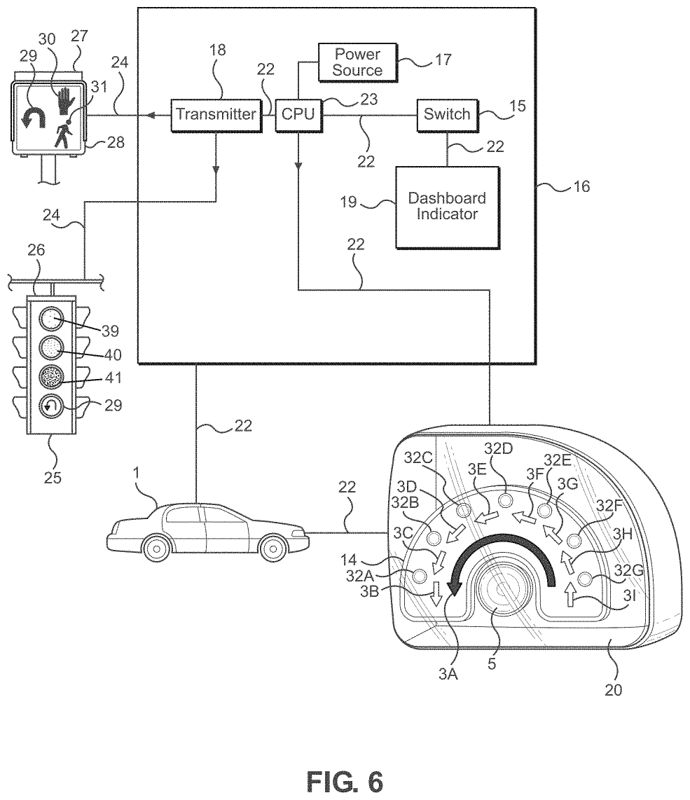

FIG. 1 illustrates motor vehicle 1 having left-side housing 2A and right-side U-housing 2B connected to an outer surface of said motor vehicle. An outer surface of motor vehicle 1 includes, but is not limited to the body, mirrors, windows, a side headlight, a side view mirror, a tail light, a turn-signal light, a housing retained on a bumper 7 (FIG. 1), a housing connected to a window and/or a windshield. Referring now to FIGS. 1, 2, and 6, left-side housing 2A and right-side housing 2B (FIG. 1) retain U-shaped housing 14. U-shaped housing 14 has inner radiused portion 6 and outer radiused portion 42. Housing 2A (FIGS. 1-3, and 6) and housing 2B (FIG. 1) retain U-turn signal indicator 43. FIGS. 1, 2, and 6 depict U-turn signal indicator 43 formed from at least one light emitting diode. Left-side housing 2A and right-side housing 2B have transparent lens 20 overlaying U-turn signal indicator 43. U-turn signal indicator 43 can have plurality of arrow shaped 3A-3E (FIG. 2) and 3A-3I (FIG. 6) light emitting diodes in a radiused and/or substantially U-shaped orientation. In a preferred embodiment, plurality of arrow shaped 3A-3E (FIG. 2) light emitting diodes may be either illuminated 4 (FIG. 3) in a solid frequency where the lights are “on” constantly when the switch is actuated or the light emitting diodes can have a chase lighting system. A chase lighting system is an electrical application in which strings of adjacent light emitting units such as light emitting diodes (LEDs) that cycle on and off frequently to give the effect that the lights moving along the string in a counterclockwise (FIGS. 1 and 2) or clockwise orientation (FIG. 1). Light emitting unit 5 is retained within inner radiused portion 6 of U-shaped housing 14.

FIG. 3 illustrates first motor vehicle 1A and second motor vehicle 1B. Motor vehicle 1B is positioned on a road next to median 9 and is in position to make a U-turn 8. When a switch of the motor vehicle 1B is actuated to an “on” position, the U-turn signal indicator 43 of motor vehicle 1B simultaneously illuminates 4 while transmitter 18 of motor vehicle 1B wirelessly communicates 24 to a remote U-turn signal indicator being traffic light 25. In particular, transmitter 18 is in wireless communication 24 with receiver 26. Receiver 26 is electrically connected to a remote U-turn signal indicator being traffic light 25. Traffic light 25 has U-turn symbol 29, red light 39, yellow light 40, and green light 41. U-turn symbol 29 of traffic light 25 is configured to be activated to illuminate when a switch of motor vehicle 1B is oriented in an “on” position to transmit a signal to transmitter 18. Then, transmitter 18 sends the signal to remote traffic light 25 to illuminate U-turn symbol 29. Motor vehicle 1A has U-turn signal indicator 43 having U-shaped housing 14 positioned on the front of motor vehicle 1A. Transparent lens 20 overlays U-turn signal indicator 43. Light emitting unit 5 is retained within inner radiused portion 6 of U-shaped housing 14.

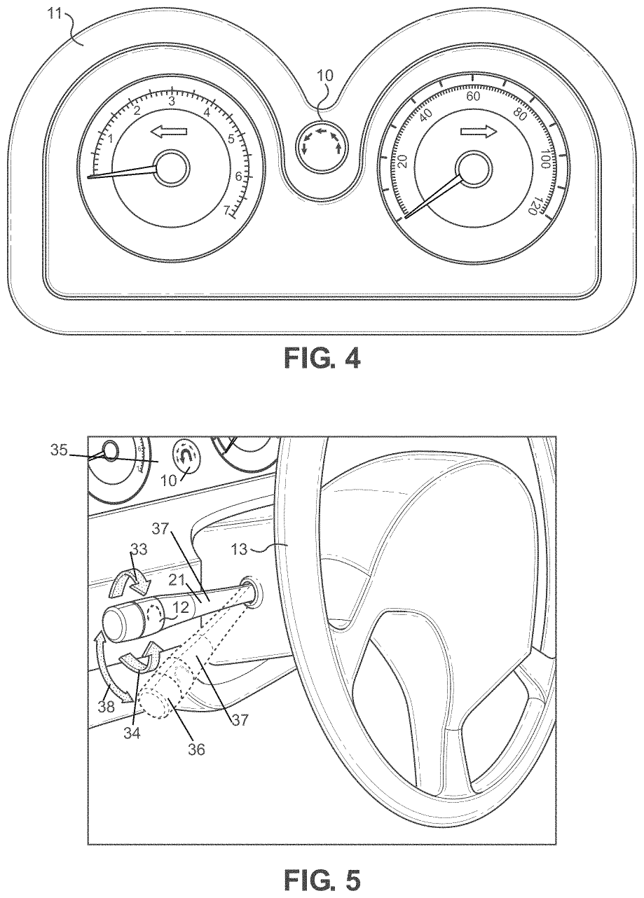

FIGS. 4 and 5 illustrate an interior U-turn indicator 10 connected to dashboard 11 of motor vehicle 1. Interior U-turn indicator 10 allows for a user including the driver of motor vehicle 1 to visually identify, by means of illumination, that switch 12 (FIG. 5) has been actuated to turn the signal “on”. Referring now to FIG. 5, switch 12 can be conveniently positioned within the interior 35 of motor vehicle 1 next to steering wheel 13. Switch 12 may be integrally formed within lever 37. When lever 37 is oriented in an “off” position 21. Switch 12 may be oriented in an “off” position 21 when switch 12 is twisted in a first direction 33 and switch 12 may be activated 38 when oriented in an “on” position 36 when switch 12 is twisted in a second direction 34. Dashboard 11 may have a first instrument panel indicator 15 and a second instrument panel indicator 19 configured to indicate data including, but not limited to, a speedometer, a tachometer, an odometer, an engine coolant temperature gauge, a fuel gauge, turn indicators, a gearshift position indicator, and/or a seat belt warning light.

Referring now to FIG. 6, motor vehicle 1 is electrically connected 22 to circuitry 16. An electrical connection 22 may be wired and/or wireless. Switch 12 is electrically connected 22 to a dashboard indicator 19. In a preferred embodiment, plurality of arrow shaped 3A-3I light emitting diodes may be either illuminated 4 in a solid frequency 3A (FIG. 6) where the lights are “on” constantly when switch 12 is actuated or the light emitting diodes can have a chase lighting system 3B-3I (FIG. 6). A chase lighting system is an electrical application in which strings of adjacent light emitting units such as light emitting diodes (LEDs) that cycle on and off frequently to give the effect that the lights moving along the string in a counterclockwise or clockwise orientation. It is within the scope of this invention for light emitting units to be oriented in a radiused and/or substantially U-shaped orientation without having an arrow shape, such as a round shape 32A-32G or the shape of a logo (not shown). Switch 12 is electrically connected to central processing unit (CPU) 23. It is within the scope of this invention for CPU 23 to be electronic circuitry within a computer that functions to execute instructions of a computer program by performing the basic arithmetic, logical, control, and input/output operations specified by the instructions. The CPU 23 may be retained on an integrated circuit chip such as a microprocessor. CPU 23 may be contained on a single metal-oxide-semiconductor (MOS) integrated circuit (IC) chip. The central processing unit 23 is electrically connected 22 to U-turn signal indicator 43. Central processing unit 23 is electrically connected to power source 17. It is within the scope of this invention for power source 17 to be a battery (not shown).

Referring again to FIG. 6, central processing unit 23 is electrically connected 22 to transmitter 18. Transmitter 18 is an electronic device configured to produce radio waves with an antenna. The transmitter 18 generates a radio frequency alternating current that is applied to the antenna. When antenna radiates radio waves when excited by the alternating current. Transmitter 18 gathers and decodes information such as when switch 12 has been actuated in an “on” position. Transmitter 18 is in wireless communication 24 with a receiver. A receiver displays the information from the transmitter in an audible and/or visual form that an individual can wither view or listen to. In a first embodiment, receiver 27 is electrically connected to a remote U-turn signal indicator. The remote U-turn signal indicator is any U-turn signal indicator that is not connected to motor vehicle 1, such as traffic light 25. Traffic light 25 has a U-turn symbol 29, red light 39, yellow light 40, and green light 41. U-turn symbol 29 is configured to be activated to illuminate simultaneously with U-turn signal indicator 43 of motor vehicle 1 when switch 12 of motor vehicle 1 is oriented in an “on” position to transmit a signal to transmitter 18. Transmitter 18 sends a signal to traffic light 25 to illuminate U-turn symbol 29 a color.

In another embodiment, FIG. 6 shows transmitter 18 is in wireless communication 25 with receiver 27. Receiver 27 is electrically connected to a remote U-turn signal indicator. In this embodiment, the remote U-turn signal indicator is pedestrian crosswalk signal 28. Pedestrian crosswalk signal 28 has U-turn symbol 29, hand symbol 30, and person symbol 31. U-turn symbol 29 is configured to be activated to illuminate simultaneously with U-turn signal indicator 43 of motor vehicle 1 when switch 12 of motor vehicle 1 is oriented in an “on” position to transmit a signal to transmitter 18. When transmitter 18 sends a signal to pedestrian crosswalk signal 28, U-turn symbol 29 illuminates a color.

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

The invention claimed is:

1. A U-turn indication system, comprising:
a motor vehicle, said motor vehicle having a U-shaped housing connected to an outer surface of said motor vehicle, said U-shaped housing having an inner radiused portion and an outer radiused portion, said U-shaped housing retaining a U-turn signal indicator, said U-turn signal indicator is formed from at least one light emitting diode, said housing having a transparent lens overlaying said U-turn signal indicator; and,
a switch, said switch is connected to an interior surface of said motor vehicle, said switch is electrically connected to a central processing unit, said central processing unit is electrically connected to said U-turn signal indicator, said central processing unit is electrically connected to a power source.

2. The U-turn indication system of claim 1, further comprising a plurality of arrow shaped light emitting diodes in a radiused and/or substantially U-shaped orientation.

3. The U-turn indication system of claim 1, further comprising a plurality of light emitting diodes in a radiused and/or substantially U-shaped orientation.

4. The U-turn indication system of claim 1, further comprising a chase lighting system.

5. The U-turn indication system of claim 1, further comprising a light emitting unit being retained within said inner radiused portion of said U-shaped housing.

6. The U-turn indication system of claim 1, further comprising said switch is electrically connected to a dashboard indicator.

7. The U-turn indication system of claim 1, further comprising said central processing unit is electrically connected to a transmitter.

8. The U-turn indication system of claim 7, further comprising said transmitter is in wireless communication with a receiver, said receiver is electrically connected to a remote U-turn signal indicator, said remote U-turn signal indicator being a traffic light, said traffic light having a U-turn symbol, said U-turn symbol is configured to be activated to illuminate when said switch of said motor vehicle is oriented in an “on” position to transmit a signal to said transmitter, whereby, said transmitter sends said signal to said traffic light to illuminate said U-turn symbol.

9. The U-turn indication system of claim 7, further comprising said transmitter is in wireless communication with a receiver, said receiver is electrically connected to a remote U-turn signal indicator, said remote U-turn signal indicator being a pedestrian signal, said pedestrian signal having a U-turn symbol, said U-turn symbol is configured to be activated to illuminate when said switch of said motor vehicle is oriented in an “on” position to transmit a signal to said transmitter, whereby, said transmitter sends said signal to said pedestrian signal to illuminate said U-turn symbol.
